(19) United States
(12) Patent Application Publication
(10) Pub. No.: US 2006/0099059 A1
(43) Pub. Date: May 11, 2006

(54) Portable retractable adjustable cargo rack assembly

(76) Inventor: Eric Edwin Ervin, Pass Christian, MS (US)

Correspondence Address: ERIC EDWIN ERVIN, 2413 N. 15th AV., Pensacola, FL, 32503, US

(21) Appl. No.: 10/966,584

(22) Filed: Oct. 15, 2004

(51) Int. Cl. B60P 9/00

(52) U.S. Cl. 414/462

(57) ABSTRACT

A portable retractable adjustable cargo rack assembly intended to affix to an existing cargo support system of a vehicle, meaning roof-mounted (but not limited to such), and to deploy to a near juxtaposed position to facilitate loading and unloading of cargo, thereby alleviating the need for vertical assistance or mechanical devices to deploy or secure. The assembly includes roller bearing housings that attach securely to the existing vehicle rack cross-members, and are secured to the portable rack assembly allowing movement over the surface of the pre-existing cross-members from a secured position atop the vehicle to an extended loading/unloading position at a near-juxtaposed position with respect to the plane of the roof of the vehicle—while remaining attached to pre-existing base frame. This invention also includes a clamping device that secures the assembly to the existing vehicle rack atop the vehicle. Two or more telescoping cross-shafts are included in this invention that may be used to secure and/or support cargo while atop base structure. A retractable support brace attached to the cross-shafts can be deployed to rest against the vehicle or telescoped to the ground to give support while loading/unloading. Two shafts or frames, positioned opposite each other, lengthwise with respect to the direction of the vehicle, connecting the roller housing and clamps to the assembly, respectfully.

### BACKGROUND OF THE INVENTION

1. Field of the Invention

This invention pertains to a portable retractable adjustable cargo rack assembly that mounts to, and is supported by, a pre-existing base structure such as a pre-existing cargo rack atop a vehicle (but not limited to such), to facilitate loading and unloading of cargo.

2. Discussion of Prior Art

At present there are a great number of vehicles on the market that are designed to facilitate cargo atop the vehicle. Most systems are comprised of two “rails” that are permanently (not particularly) secured to the roof of the vehicle and are positioned parallel and length-wise with respect to the longitudinal axis of the vehicle. A pair of perpendicular rails (with respect to the longitudinal axis of the vehicle) that attach to the lengthwise rails are positioned such that adjustments can be made to facilitate cargo between, or atop, said perpendicular rails. This system can provide means of facilitating cargo that may be heavy, bulky, or not preferred inside the passenger area of the vehicle. Therefore there may exist a problem of accessing the cargo area because of the height of vehicles such as SUVs, Vans, etc.

At present there exists cargo carriers or racks on the market to facilitate such needs by repositioning from atop the vehicle to a lower loading/unloading position, and can be retracted back atop the vehicle and secured. It is evident in U.S. Pat. No. 6,561,396 (Ketterhagen), U.S. Pat. No. 5,423,650 (Zerbst), U.S. Pat. No. 6,681,970 (Byrnes), U.S. Pat. No. 5,782,391 (Cretcher), U.S. Pat. No. 6,105,840 (Trevino), U.S. Pat. No. 5,884,824 (Spring, Jr.), and application Ser. No. 10/095,744. Unfortunately they have not been very successful in today's marketplace. As shown in U.S. Pat. No. 5,884,824, No. 6,561,396, No. 5,782,391, and No. 6,105,840, which are somewhat larger and built for heavier equipment. This invention fulfills the need for a portable device, specifically designed for lightweight equipment (such as sporting equipment), that can be easily disassembled and stored for use at another time. This invention also fulfills the need for non-mechanized loading as shown in application Ser. No. 10/383,002—which may result in additional weight of the unit and more complicated assembly. This design also operates without the need of a separate track system, as shown in application Ser. No. 10/095,744, that may also add bulk and weight to the unit. When deployed for loading/unloading this invention is supported by a telescoping brace which minimizes stress on the framework and pre-existing rack system, and, adds extra support during the process, unlike application Ser. No. 10/095,744.

In recent years the popularity of individual sports has risen exponentially, it is therefore the intent of this design to fulfill the need for a portable, adjustable, lightweight, roof-mounted loading/unloading system to assist the user in everyday situations.

### BRIEF SUMMARY OF THE INVENTION

This invention is a roof mounted cargo rack assembly intended to affix to a pre-existing base structure (or cargo rack—but not limited to such) to aid in loading/unloading cargo on vehicles that may be too tall for the user. This invention consists of two roller housings containing roller mechanisms (such as roller bearings or the like) within the housing, a bottom plate that attaches to the roller housing, and a longitudinal member joining the two roller housings. Each roller housing attaches to a pre-existing perpendicular cross-member (with respect to the lengthwise direction of the vehicle) and allows the assembly to move over the surface of the cross-members from a position atop the vehicle to a loading/unloading position near juxtaposed to the vehicle rooftop—while remaining attached to the pre-existing framework. The roller housing longitudinal joining member (positioned lengthwise with respect to the lengthwise direction of the vehicle) can be adjusted to accommodate different sized preexisting vehicle cargo racks. The longitudinal member joining the roller housing may also be removed to accommodate easy breakdown and storage.

This invention also consists of two clamping devices. The clamping devices are joined by a longitudinal member-positioned lengthwise with respect to the lengthwise direction of the vehicle. This longitudinal member can also be adjusted to accommodate different sized cargo racks, and, can be removed for easy breakdown and storage.

Joining the roller housing longitudinal member to the clamping mechanism longitudinal member are two (or more) telescoping parallel horizontal cross-members positioned perpendicular to the roller and clamping longitudinal members and perpendicular to the lengthwise direction of the vehicle, designed such that said telescoping members may traverse the roller and clamping longitudinal members, thereby adjusting the distance between said parallel telescoping members. The telescoping parallel cross-members allow the unit to be adjusted to accommodate the width of cargo load. Joined to the telescoping parallel cross-members is a telescoping support brace that can provide support for loading/unloading while deployed. The support brace connects, and hinges, to the parallel telescoping cross-members and can be positioned horizontally parallel to the perpendicular cross-members while retracted atop the vehicle.

The clamping devices are designed such that the securing position atop the vehicle may not be limited—if the framework of this invention is adjusted to accommodate the load width and covers less area than the width of the pre-existing framework.

After attaching this invention to the pre-existing cross-members the user positions him/herself on the side of the vehicle opposite the roller housings (clamping side), pulls the unit away from the vehicle until the rollers stop, and deploys the support brace. The unit is then ready for loading/unloading. Reversing this procedure will stow atop the vehicle.

### BRIEF DESCRIPTION OF DRAWINGS

FIG. 1 shows this invention from an above perspective.

FIG. 2 shows the assembly attached to the vehicle in the retracted-secured position.

FIG. 3 is a front view of this invention attached to a vehicle and deployed for loading and unloading of cargo.

FIG. 4 depicts three different views: A—from above, B—side, C—diagonal/above.

FIG. 5 is a side, and slightly angled, view of the roller mechanisms and attachments to accommodate various sized pre-existing vehicle rack crossbars.

FIG. 6 is a view of this invention from a side view—depicting clamping mechanisms and locks.

FIG. 7 depicts three views of one roller housing bottom plate.

FIG. 8 depicts three views of one of the roller housing bottom plates.

FIG. 9 depicts three views of one of the roller housing bottom plates and the roller housing.

### DETAILED DESCRIPTION

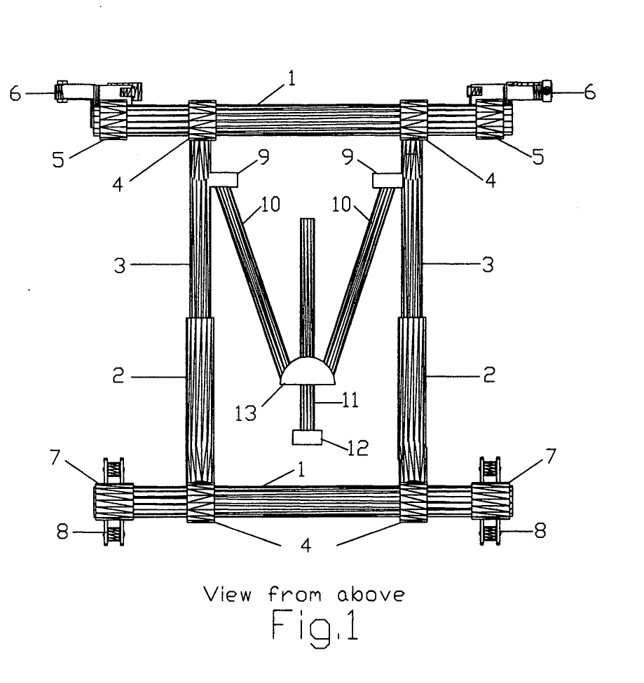

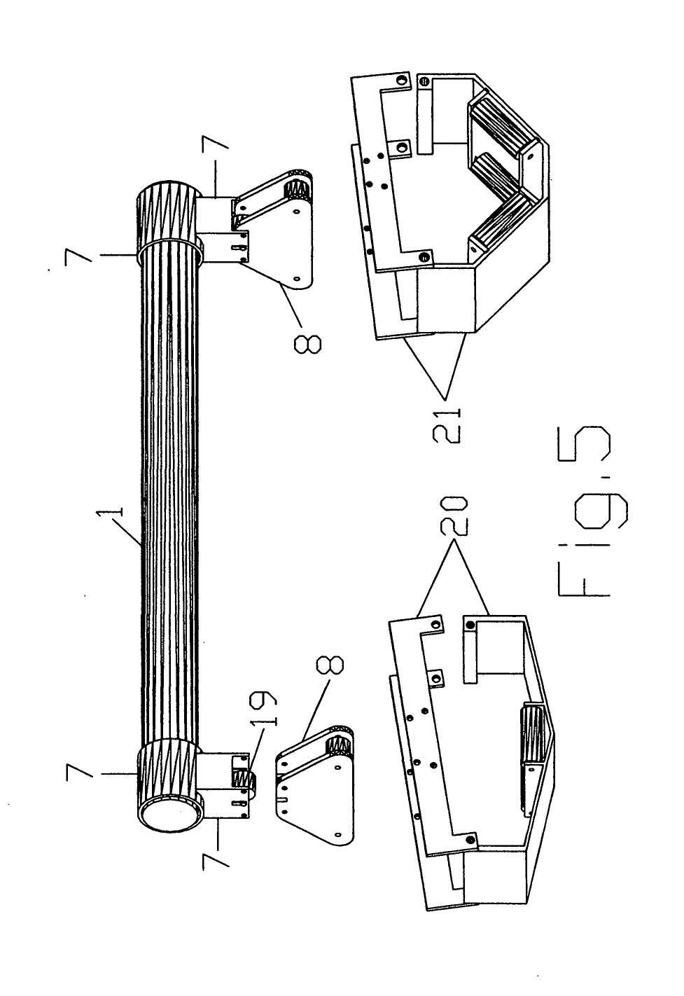

Beginning with FIG. 1, this view depicts the framework of this invention as two longitudinal rails (1) (tubular or the like) spaced parallel—joined by two parallel rails each (2 and 3) (tubular or the like) in a perpendicularly longitudinal position with respect to 1. The rails 2 and 3 are constructed such that 3 “telescopes” into 2. This allows the invention the ability to be adjusted to fit the width of load and/or roof of the vehicle. The rails 2 and 3 are joined to rails 1 such that 2 and 3 will have the ability to move slideably over the surface of 1—allowing adjustments for length of cargo and/or pre-existing vehicle rack. Joined to rail(s) 3 are two hinged connectors 9 which allow the support rails (10) and support extension (11) to move in a circular motion about an axis passing through each hinge (9). The support rail(s) 10 are connected at opposite ends from 9 by two plates positioned on the top and bottom surfaces of 10 allowing hinged movement of 10 as 2 and 3 are adjusted inward and/or outward. This also allows the support extension 11 to pass between the hinged ends of 10 at 13 and gives the invention more extendable ability (which will be discussed in FIG. 5). A soft “foot” 12 will help protect the vehicle from damage—located at the end of 11. Nos. 5,6,7, and 8 will be discussed next.

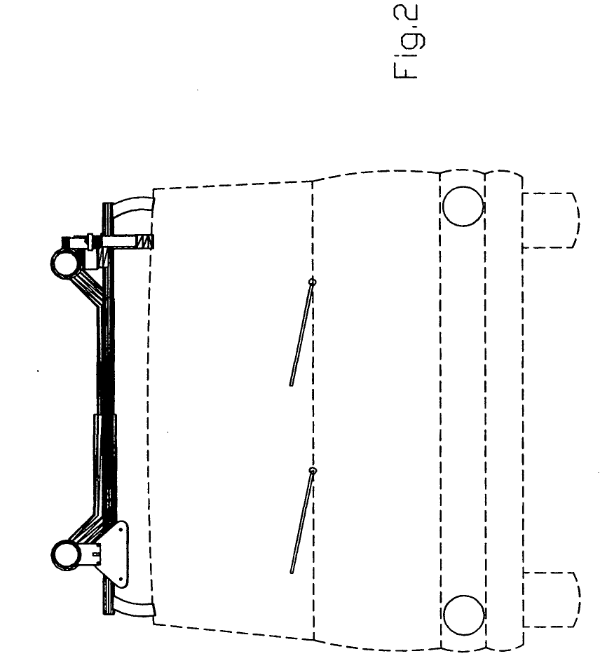

FIG. 2 depicts the invention in the secured position atop the vehicle.

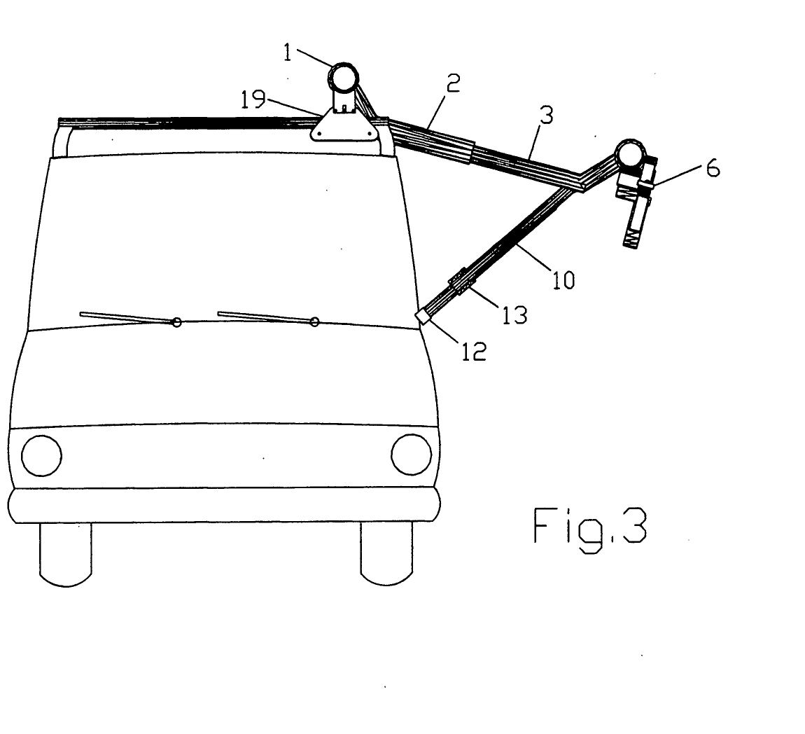

FIG. 3 is a view of this invention in a deployed loading or unloading position on a vehicle.

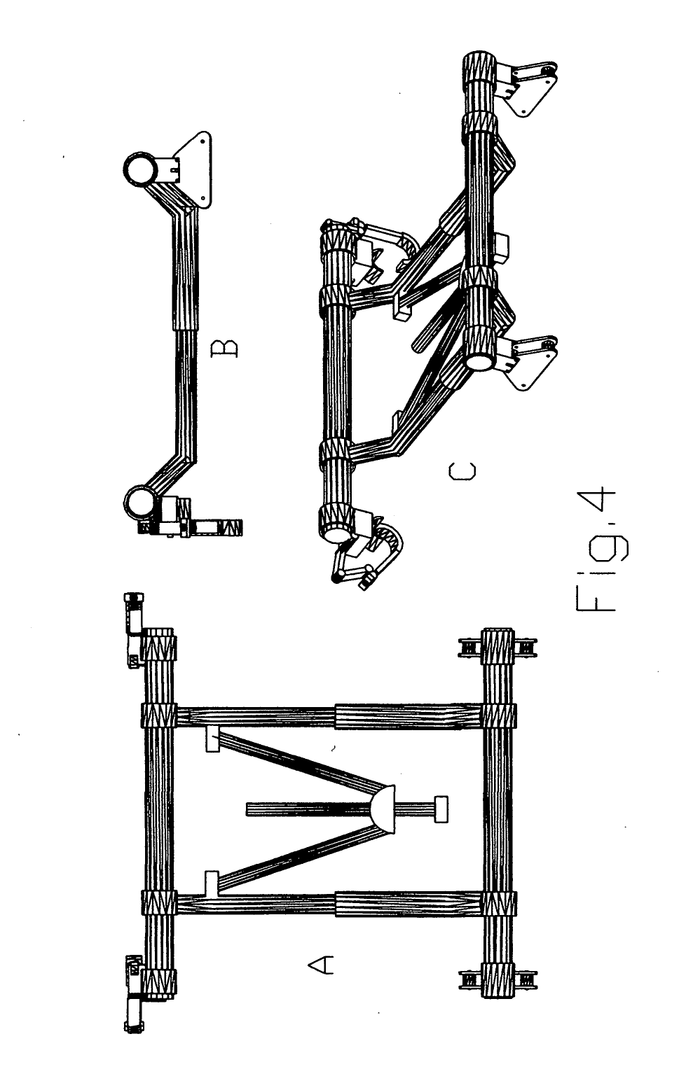

FIG. 4 depicts three different views of this invention. View A depicts the invention from an above view, showing aspects of the support rails, support extension, telescoping cross rails, and longitudinal frame rails. View B depicts the invention from a side view showing telescoping cross rails, roller housing, and clamping mechanism. View C depicts the invention from an angled above side view, encompassing the entire unit.

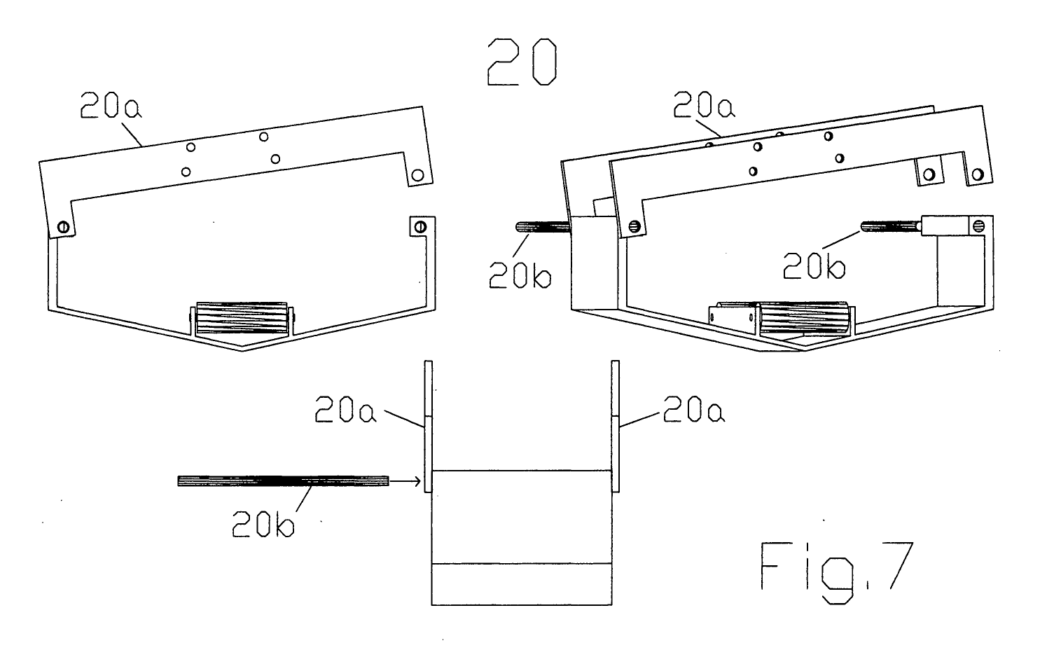

FIG. 5 is a slightly angled side view of this invention opposite the user. This view depicts the roller housing 7—the section of the invention that attaches to the pre-existing base structure. This housing (7) is placed upon the top surface of the pre-existing cross-member then is secured to the cross-member by placing one of the lower plates (8, 20, or 21) under the bottom surface of the cross-member directly below the housing and secured by means of a “rod” or “pin” placed through the surface of housing 7 and lower plate (8, 20, 21)—positioned such that the “rod” or “pin” acts as an axis joining both members. This allows the roller housing 7 and bottom plate(s) 8, 20, 21, to move across the lateral surface of pre-existing cross-members and remain secured to the cross-member. The roller housing(s) 7 is positioned such that the position of 7 can be moved over the surface of the longitudinal rail 1 and adjusted to fit the size of the pre-existing base structure and/or cargo. Because of the diversity of base structures on the market, this invention includes bottom plate designs to accommodate those differences—8, 20, and 21, which will be defined in FIGS. 7, 8, and 9.

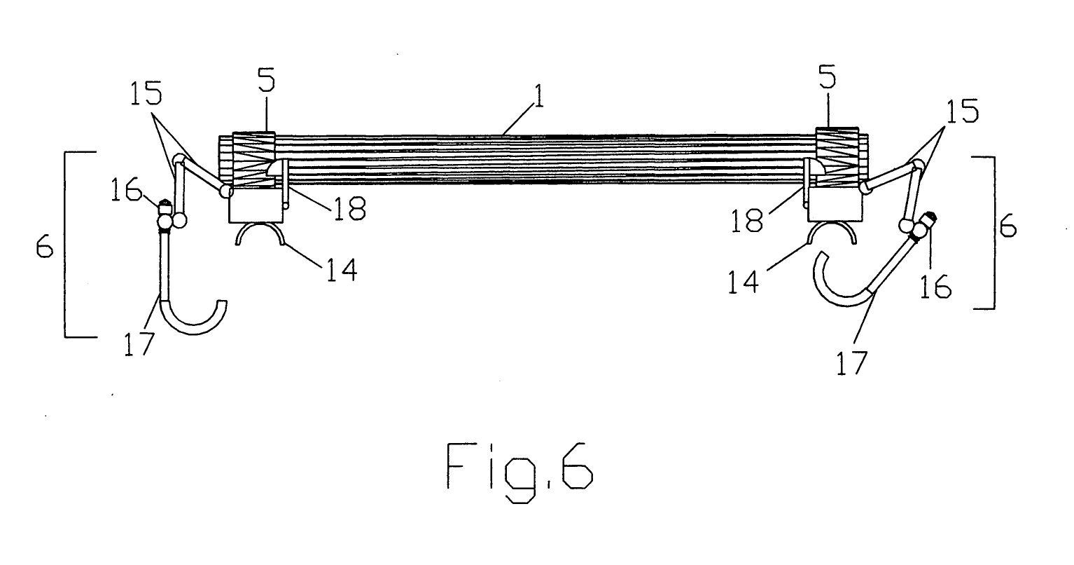

FIG. 6 shows a side view from the prospective of the user. At this angle the clamping mechanism housing 5 can clearly be shown to move over the surface of the longitudinal rail 1 and adjust to fit the preexisting base structure and/or size of cargo. No. 14 is attached to the base of the housing (5) to prevent horizontal movement of the invention when in secured position atop the base structure. The clamping mechanism 6 is comprised of three parts: 15, 16, and 17. No. 15 is comprised of two hinged plates joining the clamping housing 5 to the clamp 17. The clamp 17 is “hooked” around the bottom surface of the pre-existing cross member of the base structure and locked securely by folding the clamp plates 15 together and pressing downward over the flat surface juxtaposed to the locking mechanism 18. The locking mechanism 18 is then positioned over the hinged joint of 15 thereby holding and securing the clamping mechanism, and locking the invention into position atop the base structure. The tightening bolt 16 can be used to increase or decrease tension of the clamp 17 around the base structure cross-member. Because of the difference in vehicle cargo rack shapes and sizes, the tightening bolt 16 can help compensate the difference.

FIG. 7 provides three angles of a bottom plate 20—front view A, angled side view B, and side view C. This design is to accommodate cross-members that are a compressed-oval shape such as some Suv cross-members. This attachment is designed to be secured to the roller housing 7 and to provide lateral stability-secured to the roller housing 7 encompassing the circumference of the pre-existing cross-member. The upper securing arms 20a are secured to the housing, then the lower plate is attached by means of an axis or “rod” (cotter pin or the like) 20b, securely placed through the bored ends of the bottom plates 20 and the upper securing arms 20a.

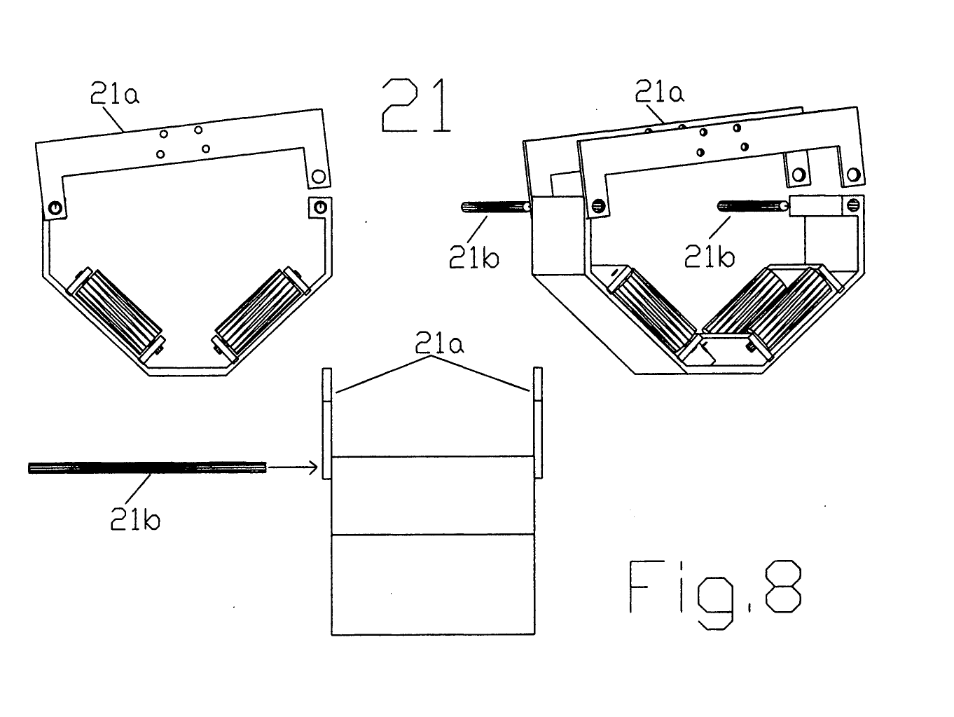

FIG. 8 provides three views of a bottom plate 21—front view A, side angled view B, and side view C. This design accommodates larger round and oval shaped cross-members. This attachment is designed to be secured to the roller housing 7 and provide lateral stability-secured to the roller housing 7 encompassing the circumference of the preexisting cross-member. The upper securing arms 21a are secured to the housing, then the lower plate is attached by means of an axis or “rod” (cotter pin or the like) 21b, securely placed through the bored ends of the bottom plates 21 and the upper securing arms 21a.

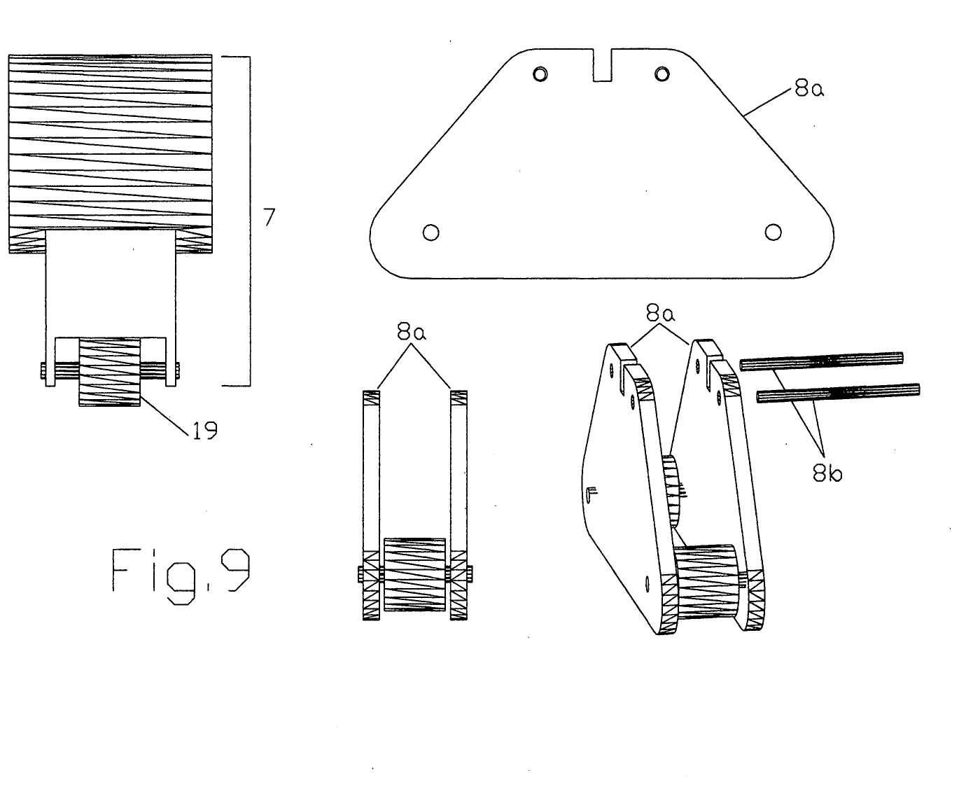

FIG. 9 provides three angles of a bottom plate 8—front view A, angled side view B, and side view C. This design is to accommodate cross-members that are round or square in shape such as some attachable base frame cross-members not purchased with a vehicle. This attachment is designed to be secured to the roller housing 7 and to provide lateral stability-secured to the roller housing 7 encompassing the circumference of the pre-existing cross-member. The side securing plates 8a are secured to the housing by means of an axis or “rod” (cotter pin or the like) 8b, securely placed through the surface of the side plates 8a and the roller housing 7 providing an adjoining axis to the two members.

I claim:

1. A portable retractable adjustable cargo rack assembly consisting of:
Means of securely attaching said assembly to pre-existing vehicle cargo rack cross members, or base structure (but not limited to such)—allowing lateral movement of said assembly along existing rack cross member surface from retracted position atop vehicle to deployed near-juxtaposed position with respect to existing base structure.
Means of securing assembly in retracted position to existing structure—as not to limit relative horizontal securing position of assembly along existing cross members.
Means of adjusting assembly to affix to pre-existing base structure.
Means of adjusting assembly to accommodate width of cargo and/or secured positioning along base structure.
Means of additional support while deployed.
Means of interconnecting above assembly as to allow said mechanisms to operate accordingly.

2. A portable retractable adjustable cargo rack assembly as claimed in claim 1, wherein an attachable roller mechanism housing(s) is comprised of:
A tube (or hollow right circular cylinder), roller mechanism housing (upper and lower), roller mechanism(s), and spring.

3. A portable retractable adjustable cargo rack assembly as claimed in claim 2, wherein said upper housing (made from aluminum, steel, or the like), constructed hollow or tubular as to allow said spring (or compression device) positioned within. Said housing is connected to said tube (or cylinder) such that the axis of said tube and said housing are perpendicular.

4. A portable retractable adjustable cargo rack assembly as claimed in claim 3, wherein said upper housing(s), comprised of one or more rolling mechanisms each (such as roller bearings or the like) are positioned within said housing and supported by a relative horizontal axis (such as screws or pins) which are secured through frame of said housing and perpendicular to the axis of said housing, also parallel to the axis of said tube as claimed in claim 3. Said axis are positioned between spring (or compression device) and lower vertical opening of said housing as to allow said roller mechanism(s) axis to move vertically along said housing axis. Said roller mechanism(s) are positioned as to allow lateral movement over the lengthwise direction of preexisting cross-member surface.

5. A portable retractable adjustable cargo rack assembly as claimed in claim 2, wherein said housing, tube, spring (or compression device) and roller mechanism(s) as claimed in claim 4 interconnect accordingly, and are positioned vertically such that surface of roller mechanism(s) contact surface of pre-existing base structure cross-members.

6. A portable retractable adjustable cargo rack assembly as claimed in claim 2, wherein said lower housing, constructed from aluminum, steel or the like, is positioned under pre-existing cross-member, relatively parallel and below said upper housing.

7. A portable retractable adjustable cargo rack assembly as claimed in claim 8, wherein said lower housing consists of roller mechanisms which are laterally secured to said lower housing by axis (screws or the like) positioned parallel to the lengthwise direction of said lower housing axis. Said roller mechanism(s) and lower housing is positioned perpendicular to the lengthwise axis of the pre-existing cross-member and below said housing as claimed in claim 5.

8. A portable retractable adjustable cargo rack assembly as claimed in claim 7, wherein said lower housing connects to said upper housing as claimed in claim 5 by means of a shaft(s) (pins, screws, rods, or the like) that are positioned pivotally through both upper and lower surfaces. Upper and lower housings are connected such that the pre-existing cross member(s) passes laterally between said lower and upper housing members and allow said upper and lower members to move as a single unit laterally across lengthwise surface of pre-existing cross-member.

9. A portable retractable adjustable cargo rack assembly as claimed in claim 2, wherein two (2) frame support poles (or shafts) (aluminum or the like, tubular or solid) are positioned horizontally parallel and lengthwise, with respect to the lengthwise direction of vehicle, above driver and passenger sides respectfully, and laterally through said tubes (or cylinders) affixed to said upper housing as claimed in claim 3, and perpendicular to lengthwise position of pre-existing cross members.

10. A portable retractable adjustable cargo rack assembly as claimed in claim 1, wherein a clamping device is used to secure said assembly to existing cross members while in retracted (secured) position (not limiting securing position).

11. A portable retractable adjustable cargo rack assembly as claimed in claim 11, wherein a clamping mechanism comprising of:
Tube or right circular cylinder, clamp mount, “clasping members”, hinged screw, and anchoring device.

12. A portable retractable adjustable cargo rack assembly as claimed in claim 11, wherein said clamp mount(s): rectangular-shaped material (aluminum or the like), contains a semi-circular “channel”, opened vertically downward, connected on the horizontal bottom of said mount. Said channel(s) is positioned such that opened surface area rests upon surface of said existing cross member when assembly is in the retracted position. The said “channel” will minimize horizontal movement, or shifting, when assembly is in the retracted (secured) position.

13. A portable retractable adjustable cargo rack assembly as claimed in claim 12, wherein said right circular cylinder is connected to the vertical top surface of said clamp mount in such a manner as to allow support pole (or shaft as claimed in claim 2) through said cylinder perpendicular to the direction of said cross members and “channel”. Said cylinder will contain means by which to “wedge” or secure shaft from lateral movement through said cylinder, such as a screw through cylinder surface (or the like) contacting shaft surface.

14. A portable retractable adjustable cargo rack assembly as claimed in claim 11, wherein “clasping members”, two plates of material (aluminum or the like), connected end to end pivotally, then connected pivotally to said mount by one end of one member to the vertical top edge of said mount. This will allow said members to fold toward themselves, in a “V” like manner, as to diminish the distance between connection to mount and opposite end of outer clasp member, respectfully. Outer clasp member will contain means by which a shaft can be connected the end opposite the side connected to the inner clasp member, such as a hinge or hole through the surface.

15. A portable retractable adjustable cargo rack assembly as claimed in claim 11, wherein said anchoring device is comprised of a “J” shaped piece of material (aluminum or the like), containing a threaded axle mount attached to the laterally top surface of the “J” as to connect said hinged screw.

16. A portable retractable adjustable cargo rack assembly as claimed in claim 15, wherein said hinged screw is connected pivotally to said anchoring device at end opposite of threaded end. Said hinged screw will contain means by which to pass through, or connect pivotally, to end of outer clasping member. Said screw may be tightened, while in locked position, by a wing nut or the like, at the upper end of the threaded area. This procedure may be used before securing to existing cross-members.

17. A portable retractable adjustable cargo rack assembly as claimed in claim 16, wherein said clamping mechanism operates to secure said assembly to existing base structure but does not limit assembly to a particular securing position along the existing cross members.

18. A portable retractable adjustable cargo rack assembly as claimed in claim 1, consisting of:
Two (2) sets of telescoping tubular shafts (aluminum or the like), right circular cylinders, two (2) load support poles (shafts, aluminum or the like), support extension pole (or shaft) (aluminum or the like), and pivot plates (aluminum or the like).

19. A portable retractable adjustable cargo rack assembly as claimed in claim 2, wherein one of two said shafts is positioned through said cylinders atop roller mechanism housings. The second of two said shafts positioned through said cylinders positioned atop clamping mechanism housing. Once secure, said shafts provide union of the roller housing and clamping housing, respectfully. Length of said shafts must exceed distance between housings attached to existing cross members. This allows roller housings and clamping housings to be adjusted laterally along said shafts, thereby accommodating to different distances between existing cross members.

20. A portable retractable adjustable cargo rack assembly as claimed in claim 18, wherein said cylinders are attached perpendicularly to the end of each of said telescoping shafts and contain an inside diameter slightly greater than the outside diameter of said support poles (shafts) as claimed in claim 2, as to allow said shafts to pass laterally through said cylinders. This allows said cylinders to move laterally along surface of said support shafts.

21. A portable retractable adjustable cargo rack assembly as claimed in claim 18, wherein said telescoping shafts are angled near each end near cylinders (as claimed in claim 21) as to render top surface of said telescoping shafts near horizontal surface plane of existing vehicle cross-members.

22. A portable retractable adjustable cargo rack assembly as claimed in claim 18, wherein two (2) poles (or shafts) (aluminum or the like) are attached pivotally between said pivot plates which allows said shafts to move in a “V”-like manner. Ends of said shafts opposite pivot plates are attached to swivel mounts connected to the inside facing surface, perpendicular to the plane of the roof of vehicle, of telescoping shafts, opposite roller housings. This allows said “V” shafts to move perpendicular to the lengthwise direction of support bars as claimed in claim 2. This also allows the angle of the “V” pivot to increase or decrease with increase or decrease of distance between opposite ends of said poles.

23. A portable retractable adjustable cargo rack assembly as claimed in claim 18, wherein a support extension pole (or shaft of aluminum or the like) is positioned between the pivoting ends of said “V” poles and between the pivot plates, thereby allowing movement laterally between planes of pivot plates, and extending the length of said “V” supports. The support extension pole (shaft) may contain a soft “foot” of rubber (or the like) to prevent damaging contact to vehicle.
